(19) United States
(12) Patent Application Publication
(10) Pub. No.: US 2009/0164282 A1
(43) Pub. Date: Jun. 25, 2009

(54) Hiring decisions through validation of job seeker information

(76) Inventor: David Goldberg, Boulder, CO (US)

Correspondence Address: BROWNSTEIN HYATT FARBER SCHRECK, LLP, 410 SEVENTEENTH STREET, SUITE 2200, DENVER, CO, 80202, US

(21) Appl. No.: 12/315,852

(22) Filed: Dec. 5, 2008

Related U.S. Application Data
(60) Provisional application No. 61/005,496, filed on Dec. 5, 2007.

(51) Int. Cl. G06Q 10/00; G06F 17/30

(52) U.S. Cl. 705/7; 707/104.1; 707/E17.044

(57) ABSTRACT

The present methods and systems relate to means for job seekers to provide more detailed information to prospective employers to aid in job hiring decisions. The means comprises validation of job history, education, and skills information provided by the job seeker, which can comprise third party support and feedback. The means further comprises a display of information that comprises the relative strength of the validation, as well as possible means of further validation for the prospective employer to use. The means further comprises a skills assessment that is taken by the job seeker at a time of the seekers time and place convenience, but that can be validated at the place of employment. The means also provides the job seeker with information about how they could improve their employment prospects.

### CROSS REFERENCE TO RELATED PATENT APPLICATIONS

This application is related to and claims priority from Provisional Patent Application No. 61/005,496, filed Dec. 5, 2007, and titled “Improving the Skills and Job Prospects of Low-Skilled Workers”.

### TECHNICAL FIELD

The present invention relates to providing means for job seekers to provide more useful, validated information to prospective employers.

### BACKGROUND

The American workforce, particularly those workers in entry-level, front-line, and first-level supervisor positions, lacks both hard skills (e.g. academic skills) and soft skills that involve knowledge of workplace culture and mechanics. The need for a system to encourage workers to invest in their development of these skills and knowledge of the “world of work” is expressed both by the business community, as well as by people who want to enter the workforce or better their position. People with particular needs are those who have either never worked, or who have been out of the workforce for an extended period of time—whether due to their bad decisions, bad luck, or a perception that they have few work options.

Furthermore, the information about job seekers that prospective employers have at their disposal is significantly limited, especially for lower-skilled workers. This information gives little information about the character of an employee, and tends to focus on negative information (bad credit ratings, criminal or driving history, etc.) rather than on positive aspects that can be revealing about potential employees.

One of the forces limiting the availability of information for prospective employers is the difficulty in validating the information provided by the job seeker. The general current scope of information provided is generally limited to job history (dates of employment and name of employer), while many important aspects of a job seeker's character are not taken into account because the information is not available or cannot be verified.

In addition, current information does not provide the job seeker either with the knowledge or the means for improving their job prospects, either through changing the format in which their information is provided to the employer, improving the level of their hard or soft skills, or by gaining concrete evidence of soft skills of value in the workplace. Many of the job seekers have little background that allows them to understand the issues of employers, and therefore present themselves poorly in hiring contexts.

### SUMMARY OF THE INVENTION

It would be preferable for the present invention to provide a method for improving the amount of information provided by the job seeker to the prospective employer.

It would also be preferable for the present invention to provide a method for validating the information provided by the job seeker to the prospective employer.

It would further by preferable to provide information to the job seeker that would allow them to improve their job prospects.

Additional objects, advantages and novel features of this invention shall be set forth in part in the description that follows, and will become apparent to those skilled in the art upon examination of the following specification or may be learned through the practice of the invention. The objects and advantages of the invention may be realized and attained by means of the instrumentalities, combinations, and methods particularly pointed out in the appended claims.

In accordance with the purposes of the present invention, as embodied and broadly described herein, the present invention is generally directed to a method for validating employment-related information regarding a job seeker for use by a prospective employer in a hiring decision. The method can comprise entering the employment-related information into a data store connected to a wide-area network by the job seeker; providing validation into the data store in conjunction with the employment-related information over the wide area network; and transferring to the prospective employer from the data store over the wide-area network the validation in conjunction with the employment-related information.

The validation can be provided by the job seeker, and can comprise supplemental information selected from the group consisting of audio information, textual information, pictoral information, or video information. Alternatively, the validation can be provided by a third party, wherein the validation comprises supplemental information selected from the group consisting of audio information, textual information, pictoral information, or video information. The third party can be contacted to confirm the validation, and the contact can be made via an automated system through a means selected from the group consisting of email and telephone.

The method can additionally comprise testing the jobs seeker's skills with a skills test, the results of which can be stored in the data store and transferred to the prospective employer. The job seeker can complete the skills test a second time under the supervision of the prospective employer.

The prospective employer can additionally be transferred information about the strength of a validation.

The present invention can also be directed to a system for validating employment-related information regarding a job seeker for use by a prospective employer in a hiring decision. This system can comprise a data store for storing the employment-related information, wherein the data store is connected to a wide area network; validation data associated with the employment-related information, wherein the validation data is stored with the associated employment-related information in the data store; and a transfer interface that retrieves employment-related information and its associated validation information from the data store for transfer to the prospective employer of the wide-area network.

The validation can be provided by the job seeker, and can comprise supplemental information selected from the group consisting of audio information, textual information, pictoral information, or video information. Alternatively, the validation can be provided by a third party, wherein the validation comprises supplemental information selected from the group consisting of audio information, textual information, pictoral information, or video information. The third party can be contacted via an automated system through a means selected from the group consisting of email and telephone.

The system can additionally comprise testing the jobs seeker's skills with a skills test, the results of which are stored in the data store and transferred to the prospective employer.

The present invention can further be directed to an electronic résumé regarding a job seeker for use by a prospective employer in a hiring decision. The résumé can comprise employment-related information onto a data store over a wide-area network; validation information for the employment-related information; and a format that links the employment related information to its associated validation information into the electronic résumé.

The validation information can comprise supplemental information selected from the group consisting of audio information, textual information, pictoral information, or video information.

The validation information can also comprise third party source information, and wherein the résumé additionally comprises confirmation of the provenance of the information. The confirmation can comprises contact of the third party via an automated system through a means selected from the group consisting of email and telephone.

The résumé can additionally comprise a score from a skills test, wherein the test is available for use by the prospective employer for confirmation of the job seeker's ability as evidenced by the score.

### BRIEF DESCRIPTION OF THE DRAWING

FIGS. 1A and 1B are examples of an expanded résumé.

FIG. 2 is a schematic flow diagram indicating the steps of progression of an applicant through INVEST.

FIG. 3 is a schematic diagram of INVEST module architecture.

### BEST MODE FOR CARRYING OUT THE INVENTION

### Overview

The present invention can comprise a set of interactions and presentations through a wide area network such as an Internet website, which for purposes of clarity and brevity of description, will be referred to in this specification as a website with the name INVEST. It should be noted that INVEST does not refer to a specific website, but rather to a set of processes and tools that can be instantiated as an interactive Internet website. The present invention, however, could also be instantiated as a telephone social network, a set of paper forms that are transferred by postal services or stored in files, or other such means of collecting and transferring information. The present invention comprises the collection, transformation, validation and display of information according to specification herein, and INVEST is one embodiment of the present invention.

Unlike existing Internet job sites (e.g. Monster, HotJobs), INVEST is not merely a site for matching employers and applicants. Instead of focusing on what the applicant currently is, INVEST provides tools and advice to obtain skills or workplace experience that would enhance applicants' possibilities. The goal is to not only help employers find the right employees for the job, but also to improve overall workforce competencies.

Unlike current workforce training through workforce development centers, schools, or community-based organizations, INVEST's assessing/training/mentoring system is automated and Internet-based, and so is scalable with consistent quality.

Unlike conventional job sites, INVEST does not simply aggregate information or automate workflow, but changes the nature of the information passed between companies and workers.

Unlike conventional job sites, INVEST is directed not only at helping people get jobs, but also at helping people keep jobs and build career paths of continuing and improving employment.

### Use Scenario

INVEST is introduced with a potential scenario of its use, describing the experience of INVEST from the standpoint of a hypothetical applicant. The narrative provides a sense of the system without abstractions or details.

As a point of terminology, the concept “ready, willing and able” comprises:
READY comprises “ready to start the process and explore the opportunity”
WILLING comprises “willing to expend the effort”
ABLE comprises “able to enter the workforce”

### Shawndra Gets a Job

Shawndra is a 22 year old minority female who dropped out of school at the age of 16 because she was pregnant. In the time since dropping out, she has had one other child at the age of 18, and has raised both children as a single mother. Shawndra goes to her friend Jamie's house, because Jamie has a computer that is hooked up to the Internet, and the two of them go to InvestInMe.com, where Shawndra registers an account with the INVEST system. According to INVEST, by her initial interest, Shawndra is mentally READY to make a commitment to the INVEST process.

Shawndra enters information about her short two-year high school career, including that she had taken a business math class, and had two years of high school Spanish. She also mentions that she was on the spirit team. For job history, she inputs that for the past two years, she has done part-time retail work at a local store during the Christmas season.

INVEST then starts to ask questions about her activities. It asks whether she has children, and whether she is the primary care-giver or not. It asks whether any of her children are at school, and if so, if she has met with and spoken to the teacher. It asks whether she has responsibilities for other children, or is a care-giver for another adult. It asks whether she is the head of a household, whether she rents or owns a home, if she is responsible for making the payments, whether she makes repairs to the home. The service asks for hobbies, whether she goes to church regularly and is known by the pastor/priest/rabbi/imam, whether she is a member of clubs and the like. Shawndra inputs that she rents an apartment, is head of her household, and that she cares at least once a week for her sister's two children. She also indicates that she attends church weekly, is well known by the pastor, and is a member of the choir. On prompting, Shawndra remembers that last year, she was in charge of food at the Easter festival. Through these questions, INVEST is building a picture of a person with responsibilities for children and household, who is a member of the church community. This is a different person than a company would see from a person filling in a conventional application form.

For each class, job, group activity, or service to another person that Shawndra has mentioned (a “referenceable activity”), the system asks whether there is a supervisor, leader, or some other person who might be willing to provide a reference for Shawndra. At first Shawndra cannot think of anyone who can provide a reference, but on prompting, she realizes that her sister (for whom she provides child care), the pastor at her church, her choir leader, the supervisor at her last job, and her child's teacher all can provide information about her. Although the value of some of these references' input may be questionable, all of them provide to both Shawndra and the prospective employer a sense of Shawndra's social support, and some level of verification of her activities both in and out of the labor market.

The program further interviews Shawndra to find the jobs that she would consider taking. She says that she would like any job involving work with children, or any job that requires interactions with people. She would rather not do work with manual labor, and would prefer a job where, because of her children and the need for child care, she could have regular hours.

All of the “interviewing” takes place with checkbox input, in which all of the input options are laid out for the user and which facilitates automated navigation and algorithms within the system.

INVEST then gives Shawndra a basic academic skills test. Shawndra is told not to get help from anyone, as she may be given similar problems at any company that hires her. Working on her own, Shawndra does fine with some skills, and less fine with others. From the results, INVEST has a rough idea of Shawndra's hard skills.

From the initial input, the system now starts to query Shawndra regarding specific soft skills, in the same manner as the initial interview. It asks whether she likes talking in front of groups, whether she likes to be a leader, if she is the type of person people come to for advice, whether she shows up on time, whether she likes to take responsibility, etc. For each skill in which Shawndra responds affirmatively, the system asks whether she has demonstrated that skill in a particular job, class, group activity, service provided or other context that could be confirmed by one of the references previously input (i.e. her choir director, her child's teacher, etc.), or can prompt her to add new references. As will be seen below, some or many of these self-reported (and therefore “suspect”) skills will be confirmed in part from the references.

The next stage of the process is to input supplementary soft skills materials: these can include photographs of children or artwork or clubs/groups of which the job seeker is a member, audio/video of the job seeker's music, literary, or theater performances, writing, flyers or clippings of activities in which the job seeker participated, etc. These materials “flesh out” the job seeker as a person, provide some verification for activities, and can, as will be seen, assist in an interview at a prospective employer. On prompting, Shawndra uploads a picture of herself on the spirit team, and a picture of her in her church choir from two months ago. She also uploads a school picture of her older daughter, and a studio picture taken last Christmas of her and both her children. She also includes a scan of the church newsletter that thanked her for her help with the Easter festival (because Shawndra and her friend Jamie don't know how to scan the pictures and upload them, they go to the local library, where someone helps them upload the files).

Then, INVEST asks Shawndra for the names, postal and email addresses and phone numbers of her references. The web service sends each reference an email asking them to help Shawndra with her web applications, and by clicking a link, they are put on a page where they can input a text recommendation. The program can then ask for specific information drawn in part from Shawndra's linking of soft skills to each activity/reference, and in part from a database linking certain activities to certain skills. For the teacher, the questions regard Shawndra's older child. Does Shawndra's child show up at school regularly and on time and dressed appropriately? To the choir director: Does Shawndra show up at choir regularly and on time? Is she a leader in the group? Does she speak well? To her ex-employer: Does she work well with others? Did she have good work habits? Would you put her on track to be a manager? These responses are used to attempt to verify the self-reported soft skills as much as possible. Two of the references that do not have an email address are sent a self-addressed stamped envelope with a questionnaire that can be filled in and sent back for automated entry.

The web service now has a large collection of information about Shawndra's job desires, her (now verified) hard and soft skills, references, and the like. Much of the information on Shawndra's skills has been verified through references, and by correlating questions asked of Shawndra in multiple ways (directly by asking about skills, and indirectly by asking about daily life activities). Since Shawndra knows that some of the information may or will be verified by employers, she has considerable disincentives for fraud. Shawndra is now considered WILLING, as she has expended substantial time—about 6 hours—in inputting the information, getting reference information, completing skills assessments and surveys. Some of her hard skills are not up to the INVEST standard, and so Shawndra is not yet “ABLE” for INVEST's credential.

Now that Shawndra is WILLING, INVEST provides her with a résumé that shows her life in an attractive format on a web site. It points out her strengths, and what she does for other people around her. Shandra asks Jamie to print out two copies of her résumé, and she tapes one to her refrigerator, and gives the other to her mother, who is thrilled and asks for two other copies.

INVEST looks not only at her strengths, but also for skills that Shawndra lacks. It can identify skills that would require only a relatively modest effort to either acquire or demonstrate. The service notices that Shawndra's hard skills are poor relative to her soft skills, and advises her to go to the site's hard skills training to improve her math and grammar skills to meet the standard. The service also notices that her references mention that she does not have good eye contact, and they refer her to a site that gives pointers on eye contact, and suggest that she find a local volunteer organization with considerable personal client contact where she can not only practice her skills, but also where she could get additional references on other soft skills.

To this point, the process has taken Shawndra and Jamie about 6 hours over three days to find and enter information. Shawndra now logs onto the service three nights a week at Jamie's house (she helps sometimes with Jamie's children as Jamie helps with hers), and over the next six weeks, she expands her math and grammar skills. The fact that she has improved these skills through the site and invested a few dozen hours is now included in her information, and both her progress and the amounts of time she is devoting to the training are reported to her at the beginning and end of each session. Her efforts and progress also become part of her resume.

At the end of each hard skills session, Shawndra is passed on to the Work Center, a set of lessons on the mechanics and culture of work. Each day, she spends 15 to 30 minutes learning how to dress, how to talk, how to work with people, when it's OK to take off from work (and when not), what to do if she thinks her supervisor is unfair. All of the lessons are filled with stories of people like her, and there are a lot of questions to answer. Shawndra still doesn't understand everything, but she's comforted that the Work Center will still be there when she gets her next job, and she can review the material whenever she wants.

In addition, from an INVEST suggestion of different volunteer positions and specific contacts in her hometown, Shawndra begins to work 4 hours a week in an assisted living facility as a daytime companion. Shawndra spends time with Mrs. Forster, who smiles every time Shawndra comes in, and Shawndra soon doubles her time there by bringing in her youngest daughter. It feels good to be able to help someone else.

Finally, after much effort, Shawndra passes her hard skills assessment, and with the nearly 50 hours she has spent on improving her skills, and the help she has been giving her pastor cleaning up after Sunday services, INVEST considers her ABLE and provides her with a “Credential to Employment”. Once again, one copy goes on the refrigerator and the other, with a cupcake and a candle, to her mother.

Shawndra is not finished with INVEST—she is still only a quarter of the way through the Work Center, and now that she isn't studying for her skills assessment, she spends more time there. Also, INVEST tells her to continue working outside her house at volunteer efforts, and once a week, she records how much time she has spent.

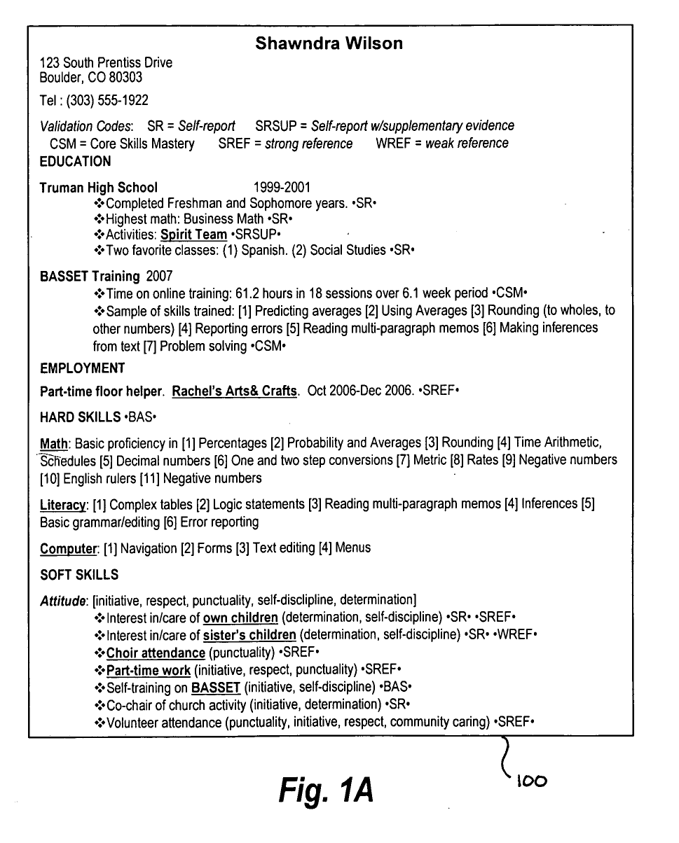

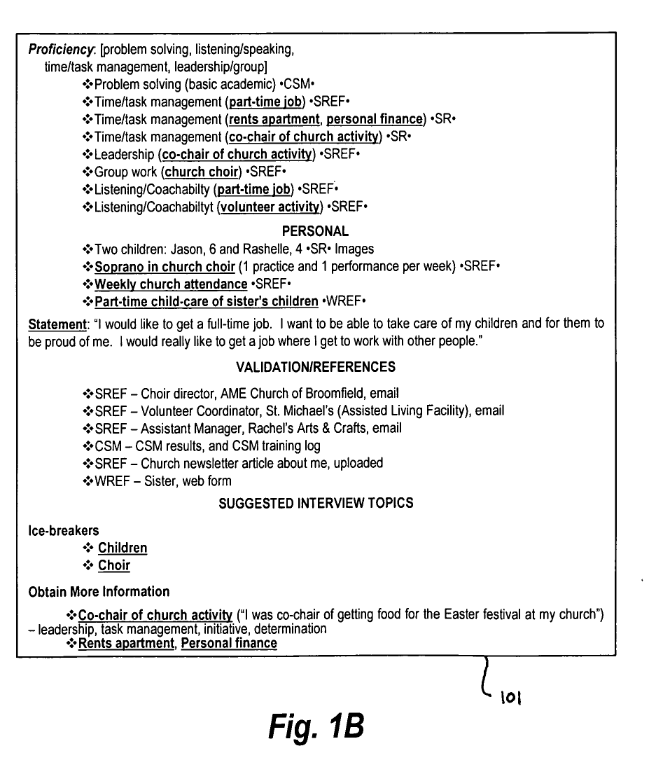

INVEST now publishes some of Shawndra's materials on its website as an “expanded resume”, and furthermore, alerts companies that have registered on the site as to the availability of these materials. Furthermore, these materials are searchable by companies looking for employees. FIGS. 1A and 1B are examples of an expanded résumé 100, 101. The expanded resume 100, 101 comprises a set of summaries of skills within different categories, followed by detailed information. The first section is a compilation of conventional résumé information. The second section is a summary of hard skills and soft skills. Each class of hard or soft skills for which some proficiency is claimed is accompanied by the supporting evidence or context. Part of the purpose of this skills summary is to provide suggested topics for an interview, both to put Shawndra at ease, as well as to collect additional support for specific skills. The third part of the expanded resume 100, 101 is a multi-page in-depth compilation of the information obtained from Shawndra.

The résumé can exist in both paper form and a web form with hypertext links to recommendations and supplementary information, and can be formatted either for Shawndra's personal viewing (in either bulleted or narrative form), or for an employer. An example of an employer's version of Shawndra's résumé, formatted in brief form for an interview situation, is presented below.

Regal Corporation has a registration with InvestInMe.com, which allows it to scan through the published expanded resumes. Regal Corporation has an opening for someone of Shawndra's skills, and through the site, arranges for a meeting. The interview starts a little awkwardly, but when the interviewer mentions Shawndra's two children (as suggested in the résumé), she responds enthusiastically. They talk about how she likes her church choir, and her part time jobs. Shawndra likes the interviewer, and she is smiling and looking her in the eye. With most resumes, the interviewer has only the years of schooling, a brief job history, and contact information on the job seeker, but here, she has a picture of a person engaged in the world, liked by her peers and with a reasonable social support network, with some organizational skills in running a household, a serious attitude towards her children's raising and, by evidence of her taking the effort to improve her hard skills, a person with the drive and ability to work towards her own future. Her ABLE credential indicates that her academic skills are, in fact, generally higher than most high school graduates, and she is comfortable with computers. It is not hard to see her future with Regal Corporation. She is offered a job as a Level I Desk Support Associate in the hotel chain.

### Shawndra Builds a Career

Six months into her job, Shawndra is doing well at Regal Corporation. Her work experience is not, however, without problems. She does not always get along with her supervisor, and finds it increasingly difficult to hold her tongue, and she doesn't know how to do some of her tasks, but is embarrassed to ask people for assistance.

Shawndra already trusts INVEST—it gave her a résumé, it helped train her, and it got her a job. It is now part of her “community”, just as her mother and her friend Jamie are. Her mother can't help her with her job problems, and she doesn't think that Jamie has good ideas. She logs onto INVEST and types into the box that says “Do you have a problem?”—“I don't get along with my boss. He criticises me too much.”

With its natural language processor, INVEST sees through Shawndra's bad spelling, understands the gist of her issue and a box pops up and says “Shawndra, tell us about the problems with your boss”. Shawndra writes a paragraph about her problem, and INVEST: a) parses her paragraph and determines the existing sections of the Work Center that addresses issues similar to Shawndra's, b) finds a “Supervisor Problems” forum that speaks directly to her problem and has some other people's stories and the advice they were given, and c) sends her message to the “Supervisor Problems” forum.

From the Work Center and the Supervisor Problems forum, Shawndra finds that her problems are not unique. The Work Center provides specific ideas on how to deal with the situation, and the forum provides emotional support as well as some more specific feedback. The forums are lightly monitored to prevent inappropriate advice, but people on the forums are, for the most part, people who understand the importance of constructive support, since they are or have been in Shawndra's position, and know the value of the job to Shawndra. Indeed, within the next 3 months, Shawndra will feel comfortable enough to start to give her own advice.

From INVEST, Shawndra learns ways of talking to her supervisor, and gets through this problem. Shawndra uses INVEST only a little over the next 9 months, but as her youngest daughter reaches kindergarten age, Shawndra feels like she can do more—she will have more time, and she feels more that she wants to be a model for her children. She logs into INVEST, and scans through the system, looking for advice how to move up from her current position.

INVEST asks Shawndra some details about her job, and from her responses, begins to construct a skeleton career—where she could potentially be in 1, 2, 4, and 8 years. It suggests that in 8 years, she could be assistant manager of a hotel, but that to reach this, she will need to meet certain requirements, and will need to make herself visible to management. It sends her to a section of INVEST on advancement within large hospitality companies, which Shawndra prints out and reads with care. It will help to take two classes at community college, and she will need to be sure to make her interests clear to her supervisor, and ask for company policies on advancement. For Shawndra, this is a long-term project, but she cares about the long term, and who knows, by the time her daughter goes to college, Shawndra could be a hotel manager.

### Strategic Considerations

INVEST comprises an employment system for helping groups who are on the fringes of the traditional workforce either improve their work success or, for those outside of the traditional workforce, integrate into the work community. The groups of particular interest include 18-26 year old dropouts who have never had regular employment, people coming out of the criminal justice system, women or caregivers returning to work after extended periods without traditional employment, recently legalized immigrants who are entering the regular employment system, and more. A goal of INVEST is to provide these people with a sense of belonging to the “world of work”, and a sense of a career path—that is, that their work life consists of more than moving from dead-end job to dead-end job. Without this sense of a positive trajectory, people have no incentive to invest in their themselves—their skills, their education, their attitudes.

INVEST has two distinct and equally important audiences: the target populations and the employers who will employ them. As will be discussed below, even though INVEST is developed specifically to assist the target populations, the system is available for all employment candidates (the “applicants”).

INVEST creates a novel structure for gathering a wealth of information about each applicant, and uses this to create holistic résumés that enable employees to showcase skills and attributes that might not appear on a traditional résumé. This should make them more appealing applicants, as well as enable employers to choose employees who will be a better fit for their needs. Furthermore, INVEST will provide a credentialing system for informing employers about the skills of an applicant, and the tools for applicants to gain those credentials.

The key to INVEST is that it doesn't simply help applicants find jobs, but rather it prepares the applicants for employment. To do this, it provides incentives for applicant self-improvement, as well as offers concrete tools for applicants to use in understanding their career path and broadening their skills. For employers, increasing the number and quality of applicants is a critical business goal.

To successfully meet its goals, it is preferable that INVEST meet the following prerequisites:

1) INVEST should be able to report those qualities in applicants that are likely to be associated with improved chances of success in the workplace.

2) INVEST should be able to attract, engage and retain applicants from a wide range of work and personal experience, skills, and cultural and socio-economic backgrounds.

3) INVEST should provide means and incentives for applicants to improve their skills.

The following subsections will discuss at greater length the means by which INVEST meets these requirements.

### Identify Qualities for Applicant Workplace Success

Many qualities are widely believed to correlate with workplace success, including:
Work and educational history;
Hard skills—which include academic skills and technological knowledge;
Soft skills—which include speaking and listening, teamwork and leadership skills, knowledge of workplace culture and processes;
Attitudes—which include work ethic, initiative, responsibility, and adaptability;
Personal assets—which include creative expression, spirituality, and community.

Current methods of assessing candidates with employment tests and interviews and assessments by human resource professionals have not changed substantially in decades. With the advent of new tools in statistical analysis—such as neural networks, decision trees, Bayesian analysis and other data mining tools—it seems a reasonable goal to devise a scoring system based on the information indicated above to accurately estimate an applicant's probability of success at the company. Let's examine this possibility for a moment.

In order to use this information for work success prediction, INVEST needs to be able to measure the important qualities, and then determine how they combine to contribute to workplace success. Hard skills are generally considered to be the qualities easiest to measure, yet our ability to measure even these with a high degree of accuracy is questionable. Our ability to accurately measure soft skills, attitudes, and personal assets are much lower. Furthermore, it should be appreciated that an applicant's mix of these qualities will change over time. Parenting a child, for example, can change a person's worldview overnight, and a first job will very quickly enhance a person's soft skills. That an applicant had a criminal record 2, 5, or 10 years ago may not provide a meaningful insight into their current state.

If one wishes to accurately estimate the chances of workplace success, one would also need to consider the specific job that the person is applying for and how it fits with the specific skills and other attributes of the applicant, the type and effectiveness of supervision that the applicant will receive, various aspects of corporate culture (e.g. authoritative versus relaxed), and detailed aspects of the worker's life (does it take 2 hours on buses to get to work? are they abused by their spouse? do they have hidden mental illness? are they in financial distress?). Many, if not most, of these factors will not be available to our system.

Furthermore, from a mathematical perspective, there are dozens of degrees of freedom, which means that the amount of data needed to obtain an accurate and statistically valid prediction is extraordinary high (the amount of data required scales exponentially with the degrees of freedom). Most likely, one would need data on many millions of applicants, with a far richer depth in information than has been gathered to date, and it would need to include information on workplace success, which is very hard to assemble.

Furthermore, the way that statistical predictive tools work is to focus initially on the “low hanging fruit”—those few predictors that have the most predictive power. A statistical predictive tool would almost certainly exclude the people that INVEST is most directed at helping.

Simply put, statistics is not going to solve this problem, and one must look elsewhere.

Without question, for the foreseeable future, the primary “line of defense” for employers will be the personal subjective assessment of HR hiring personnel. INVEST will supplement the subjective judgment of these personnel by providing them more complete information about the applicant.

Let's consider first some of the problems in the current hiring process. As stated before, the information that an HR manager has about an applicant when making a hiring decision is highly limited, and often does not speak directly to the tasks that an applicant will need to do if hired. As the hiring personnel do not have the information which they need, it is easy for biases of various sorts to sneak into the hiring process. Many employers have active diversity programs. However, there is substantial evidence that minority and “unusual” applicants have lower success throughout the employment process, which is due in part to hidden biases in hiring personnel, and indirect biases in automated screening (e.g. screening for education will indirectly screen against groups with overall lower educational achievement). It should be noted that hiring personnel who choose a high-school dropout or a candidate with a criminal background might be held particularly accountable for that hire, whereas they will not be questioned for hiring a conventional candidate, even if the questionable applicant has higher potential.

To counter this, INVEST will try to bring out strengths that may be hidden in the “unusual” applicant, and will try to make the applicant “come alive” to the hiring personnel through a large variety and depth of detail. To the extent that INVEST exposes an applicant's strengths and make the applicant “real” to the hiring personnel, the more willing the hiring personnel will be to make a “bet” on a person with drawbacks in their résumé. Presumably, the hiring decision will be improved when dealing with actual people than with the highly sanitized, self-reported documents that are conventional résumés or job applications.

### Attract and Hold Applicants

INVEST's target population is characterized by a combination of hope and skepticism. They want to believe that they are better than their current circumstances reflect, and that they have a chance to make things right. At the same time, they may be skeptical that they have the personal qualities to actually follow-through on their desire for improvement, and they likely don't trust that the conventional employment processes—that has done so little for them in the past—will either help them or, for some people, even allow them to succeed in the future. Overlaid on this complex psychological ground is often a near total ignorance of how the system works, what success is actually possible, or what success would even mean for them. A system that does not take this psychological and knowledge mix into account will limit the number and types of people it can help.

The methods used to attract and hold applicants need to forthrightly nurture the hopes and allay the skepticism of the applicant population, and need to start this process before the applicant has committed to the INVEST process. The essence of this effort is centered on establishing and building trust, which is necessary for a healthy “relationship” between INVEST and the applicant.

Trust, in the end, is based on two notions:

1) Truthfulness. The applicant should feel that INVEST will deal with them truthfully, and not sugar-coat the possibilities or downplay or exaggerate the difficulties.

2) Commitment. The applicant should feel that INVEST will be with the applicant through “thick and thin”. If the applicant “fails” the system (e.g. doesn't do the training suggested by INVEST), INVEST can truthfully inform the applicant that the applicant's chances of employment have been hurt, but the response cannot be callously punitive (kick them off the system). Inherent within this commitment is the knowledge that INVEST will not use information provided by the applicant “against” them.

It should be noted that the ethos of INVEST should be to make these notions reciprocal. For example, lack of truthfulness on the applicant's part (e.g. fraud in references or self-reports) would be a catastrophic strain on the relationship.

Although INVEST's paying customers are the employers, to whom the system will have an ethical and financial responsibility, INVEST will also have an equally deep responsibility to the applicants. There may be, in fact, information about applicants that INVEST will withhold from employers, and INVEST will need to inform the employers about the information that is being withheld and why. It should be noted that this conflict of interest is an inherent aspect of all commercial job sites. Managing the conflict of interest will be an important tension during INVEST's design. It should be pointed out that this conflict of interest is of a much more serious nature than that which faces conventional job sites due to the deeper and more personal information that is collected on the applicants.

In addition, INVEST will attend to psychological factors as well as procedural factors (how to input contact and reference information, assess certain skills, etc.). In addition to truthfulness and commitment, INVEST will use various methods of providing positive feedback. Many of the applicants will initially have many skills which will need improvement, and from the starting position, the amount of work to be done to become workplace-ready might seem overwhelming. For example, INVEST will provide intermediate credentials as sub-goals to the much larger effort of becoming workplace certified. To keep applicants motivated and feeling self-confident, INVEST will, for example, provide chances for community members who know the applicant to input recommendations of the applicant that the applicant can review. Also, at an early stage, the applicant will be given a résumé created by the information received from the applicant that will hopefully allow the applicant to better appreciate their skills, strengths, and other assets that they may not themselves understand or appreciate.

An important aspect of the methodology of INVEST is to allow the applicants to see themselves as having personal assets that are of value, and which they can improve through further effort using tools provided through INVEST. Once this vision is achieved, the applicants will want to stay within the system to extend the affirmation of themselves.

### Provide Incentives and Means for Applicant Improvement

The goal of INVEST is not simply to pick and choose who gets entry level jobs, but rather to increase the overall skills, attitudes, and other qualities of the applicants. Furthermore, the goals of INVEST do not stop when the applicant gets the job, but rather the system will continue to support them through their first job or two, until they “get the hang” of the work environment—to make them better workers. This should occur through a combination of providing incentives for applicants to increase their skills and change their attitudes, and providing concrete and practical means for them to do so.

Incentives

The first step in setting incentives is to provide a framework that answers: what does one want people to do, and why should they want to do these things?

As the name of the system indicates, it is preferable for people to “invest” in themselves. Instead of hanging out at a bar, or playing video games, it is preferable for them to do something that doesn't come naturally for most people—studying, taking a volunteer job, “sucking it up” when they are shown disrespect from their supervisor. The essence of such investment is delayed gratification—I put off doing today what is fun and easy to do, so that I can get something of value in the future. In order to practice delayed gratification, the key is seeing something of value in the future.

If a person sees their life as a series of low-paying, low-respect dead-end jobs, they are not going to invest their spirit or their time in the process. The way that the middle and upper classes create that sense of future prospect for their children is through the narrative of a “career”. A career means that you start “here”, and through hard work and doing time and learning and gaining credentials, you get “there”. Doctors, lawyers, scientists, engineers, and business people have careers. On the other hand, line workers, bed changers, retail clerks, and sanitation workers have jobs. In the inner city, children overwhelmingly see people with jobs. At a strategic level, the cultural capital that the middle classes provide their children is, in many ways, encapsulated in the concept of a career, and the concrete practical tactic taught to achieve that goal is that of delayed gratification. It is a goal of INVEST to help introduce these concepts to people who did not grow up with these notions.

The way to do this is not to tell all applicants that they can become a lawyer, but rather to broaden the concept of “career” to include an arc from:
apprentice plumber to plumber to owning a plumbing business.
housecleaner to day supervisor to assistant desk clerk to desk clerk to assistant manager.
line worker grade 1 to line worker grade 2 to first-line supervisor and union representative

In perception, a career is an arc of increasing responsibility, respect, value, and compensation. In practice, a career is an arc of increasing skills, knowledge, social network and experience, but it is based on a foundation of consistent diligence, patience, and heart.

The challenge of INVEST is to lay out to applicants the importance of looking at each job as part of a career, and to help them build a narrative of this with themselves as the primary actor. This narrative cannot appear to be a fantasy, nor can it be too challenging—it needs to be realistic and enticing. INVEST will do this by presenting to applicants careers that they can “try on”. There will need to be some experimentation to understand the best way of doing this, but it is likely to comprise, in part, an interactive tool that lets the applicant choose from among different career successes, and to work their way back through to a first (or current) job. This tool could include a sample timeline, as well as an indication of the skills, experience and knowledge that they will acquire at each step in the path, and the ways in which they could improve their success through personal effort (credentials, study, etc.).

Roughly speaking, people with “just” jobs fill in applications. People with careers have résumés. One key tool for INVEST is to give each person a résumé, which provides them a mirror into their personal assets and the arc of their work lives.

The “crime” here is that people who start with the means to choose traditional careers never have to do the hard work of constructing their lives. Their deep social networks tell them: work hard, take these tests, go to college, work hard, go to graduate school, follow the path and you will succeed. People without this social network and capital are “open field running”—they need to, without any real assistance or guideposts, create for themselves a roadmap to success. INVEST will be there to help them.

Means

The previous sub-section discusses incentive. Once the person has the incentive, it is preferable to give them the means and tools to realize their new objectives.

Given the limited financial and personnel resources of community-based organizations and government organizations devoted to workplace training and to improving the prospects of this population, any system that requires assistance from these organizations is not scalable to meet the needs of the millions of people who could benefits from INVEST. To the extent that INVEST can provide universally-available free tools to aid efforts by such organizations, those organizations will be able to focus on services to the target population for which they are best suited (e.g. counseling, working with employers, working on soft skills not amenable to Internet training). Internet provision of automated training and counseling services is an absolute and practical necessity.

It should be noted that training cannot be an afterthought to be tacked onto INVEST, but rather INVEST should be structured around the training. That is, if INVEST's goal is to improve the workforce, there needs to be a practical plan for improving applicant qualities that will have a material effect on workforce performance.

What the employers will see, however, is not the training, but rather the effects of the training in INVEST's assessment of applicant characteristics. As will be seen in a later section, there are a large number of applicant qualities that INVEST will assess, covering hard skills, soft skills, attitudes and personal assets. All of these qualities contribute to a full view of applicant workplace readiness, but there are two areas that are of highest importance to employers.

1) Hard Skills—Employers desire these skills, either on their own account, or as proxies for the ability to learn other skills on the job, intelligence, diligence, etc. Furthermore, there is likely to be more trust of measures of hard skills, as these types of skill seem more amenable to measurement than teamwork, speaking, listening, and other soft skills.

2) Coachability—Coachability is a term covering a set of qualities related to the willingness and ability to take direction, and the degree to which the applicant is a “team player”. This is clearly a necessary quality for employment, and bespeaks an applicant's positive attitude towards work and to being supervised. An employee may be lacking certain soft skills, but if they are coachable, when their supervisor speaks to them about how to manage their time or smile at customers, they will try to improve their performance, and the chance that the improvement will “stick” is high. Coachability is hard to measure, but is evidenced by prior work history, references, and participation in sports, choirs and other group activities.

A focus on offering meaningful and effective training in both hard skills and coachability is a key element of INVEST. For hard skills, INVEST will incorporate a free, Internet-based training program called Core Skills Mastery (CSM) that is specifically directed at assessed skills. For those applicants lacking the computer skills to use this training, CSM includes a means of training users in computer usage through a computer interface. There will be some applicants with developmental and/or other disabilities that will not be able to successfully complete the CSM hard skills training, but it is expected that the large majority of applicants can be successful at meeting the CSM standard if they are diligent in the training.

INVEST's approach to coachability is three-fold. In a first approach, computer methods (narrative, computer-based training, simulations) are used where the applicant coaches other people, or sees the coaching from a third-person perspective. This allows the applicant to understand the need for doing things correctly, the benefits of listening, and the usefulness of coaching. In a second approach, connections are made to personal stories of success through mentoring. These stories serve to help people model their efforts and their future. Narrative is one of the most powerful teachers and should be used to good effect in INVEST.

In a third approach, applicants will be encouraged repeatedly to find an activity that requires some teamwork or expertise through coaching to engage in. These activities can be singing/dance/rap or other artistic groups, martial arts, sports clubs, volunteer work, church groups, etc., where the applicant participates in sole or organized activities under the guidance of a coach. These activities have any number of benefits to the applicant, including learning about teamwork, gaining self-esteem, connecting to a community, seeing that they are powerful enough to help someone else, exercising creative expression, showing initiative, persistence, and responsibility, and at the same time creating relationships with people who can provide references. This is a central feature of INVEST, and will require considerable effort to help applicants by cataloging and listing activities—not simply categories of activities, but specific activities and organizations in many locations around the country—in which they might participate.

It should also be understood that INVEST is not simply for getting a person a first job, but to support them through that job and then into their second and third jobs or positions. People who obtain a job through INVEST are not necessarily going to succeed at their job without assistance. And once INVEST has proven successful with these people, a bond of success and trust is established that has value in directing the person through whatever issues they encounter.

### INVEST Process Overview

### Applicant Process

INVEST is a workplace readiness system, with an embedded free assessment and free training. The outcome of INVEST for an applicant is a Ready, Willing and Able (RWA) credential. In this section, the logical flow from stage to stage of this process is presented.

Ready

Before the process can be started, one needs to get enough information about the applicant to populate an initial record. This information will involve, roughly speaking, the input of basic biographical information, and for the applicant to establish a username and password so that they will be able to re-enter INVEST at a later time.

An applicant who inputs this information is considered READY—at that point they are looking for a solution to their current employment status, and are investigating possibilities through their use of INVEST. That is, the term READY is used not in reference to “ready for employment”, but rather “ready for INVEST” (i.e. their mental state of readiness to begin the process).

Notice that the requirements for READY are minimal. It is important to be inviting and to allow the applicant to slowly gain commitment.

A person who is READY is given access to the entire INVEST training suite.

Willing

Willingness is a state of mind. While Ready means that an applicant is open to take a very tentative first step, Willingness means that an applicant is willing to expend some effort to gather and enter information into the system, to assess their skills, to contact people in the community as references. It should be noted that from the applicant's point of view, they are primarily “giving” to the system rather than “receiving” at this point.

This part of the process constitutes three parts. In the first part, the applicant is introduced to the process and the system—it describes what they will do and what they will get. Given the large amount of effort to be asked of the applicant in the next two parts, it is important to inspire motivation. In this introduction to INVEST, they will be shown samples of specific products that they will be able develop from their efforts at this stage of the process. These products will include a résumé which highlights their personal strengths, as well as their social network and links to the community. In addition, they will obtain a personalized assessment of where they stand in terms of their appeal to potential employers, and suggestions of things that they could do to enhance their potential for both getting and succeeding at a job. They will also be told that their résumé can be put, at their request, in a place where potential employers can view it.

In a second part, the applicant is asked to put in a large amount of information related to their employability, including detailed biographical information, work history, certain personal information (voluntary), and contact information for references.

In a third part, the applicant takes a hard-skills assessment. This assessment serves as an important aspect of marketing the service to companies, as the perceived value of such an assessment is high. Furthermore, the assessment is the best immediate indication of the potential of the applicant in the workplace, and provides clear goals for the applicant that the system can provide.

It should be noted that these assessments, such as CSM, are intense and can take 2 or more hours to complete (and this does not include the time, which could be a few hours, required to enter the biographical, work history and personal information, and possibly more time to organize contact information and supplementary material). Someone willing to take the time to enter the information and take the hard skills assessment is considered to be WILLING. That is, the applicant is WILLING whether or not they pass the hard skills assessment, and in this sense, WILLINGNESS is self-evidenced by their activities on INVEST, rather than through some formal assessment of willingness, or report of external activities.

It should be noted that it can be useful to include more evidence of willingness other than the hard skills assessment. That is, INVEST could also require the applicant to: (1) view and show knowledge of some of the Work Center modules, (2) take a soft skills assessment, (3) take a job interest or personality inventory, (4) show evidence of time management and/or punctuality (see below in section 3.3), etc.

The primary reason for having a “lax” meaning of WILLINGNESS is that it is preferable to have a low barrier in general for people to get into the system, and to be inclusive to the extent possible. Small “hurdles” get people gradually into the system, and are motivational. For each small set of activities within INVEST, it is preferable would like to provide feedback, a résumé, a credential, etc. On the other hand, it is preferable to avoid the suburban soccer issue of every child being given a trophy, which diminishes the credentials.

Able

The specific skills that are assessed by the hard skills assessment are such that at the conclusion of the assessment, a first selection process can take place. Those who pass this selection will be considered Ready, Willing and Able. The algorithm will use a combination of biographical information and the hard skills assessment to derive a score for ability.

The rules that are used in the selection process will change over time with the availability of feedback for employers and applicants. It is possible that the initial rules will come from expert systems, as such systems are relatively robust in the absence of strong empirical data.

It is also possible that a requirement for being considered Able is to complete some training in Work Center. There is an issue here in that “advanced” applicants who use the system may not require this training. It can be preferable therefore to have a threshold of prior work history, education, or other applicant characteristics that may release the applicant from the obligation of Work Center.

It should be noted that the assessment will, in general, not be taken at accredited assessment centers. As such, it is possible that the applicant will have had assistance from others, and the ability can be considered to be provisional. Thus, it is assumed that employers can require people to take the assessment onsite to verify the applicant's ability.

Furthermore, even if the applicant does take the assessment at an employer, it is not clear that INVEST will wish to validate the score, since it is possible that there will be smaller employers or individuals at larger employers who fraudulently enter information. In general, it will be considered the employer's responsibility to validate an applicant's hard skills score when the applicant visits the company.

Applicant Process Summary

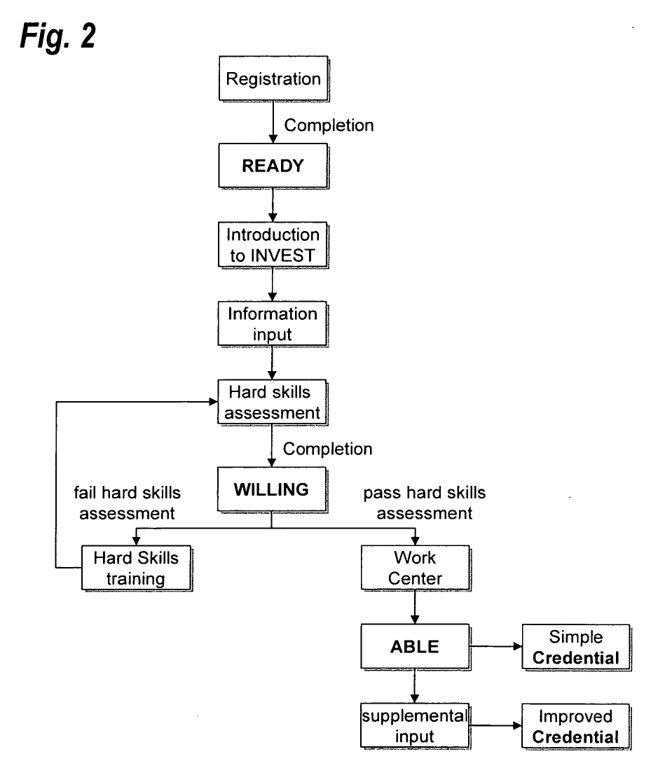

FIG. 2 is a schematic flow diagram indicating the steps of progression of an applicant through INVEST.

On completion of Registration, the applicant is considered mentally READY to enter the INVEST process (and, by extension, the job market). On completion of the hard skills assessment, the applicant shows his willingness to engage in the effort to complete the INVEST process. If the applicant fails the hard skills assessment, they are directed to obtain hard skills training, which is optimally part of the INVEST system. After completion of training, the applicant could then re-take the hard-skills assessment. At this point, it can also be preferable to direct applicants to enter into the Work Center at the same time to make sure that they are positioned for the Ready, Willing, Able certification as soon as they have passed the hard skills assessment.

If the applicant passes the hard skills assessment, depending on their overall characteristics, they may or may not have to demonstrate additional effort through completing some of the Work Center training. This Work Center can also include certain assessments of soft skills, such as communicating with the system at given agreed on times. At the completion of this phase, the applicant is eligible for a simple credential demonstrating their Readiness, Willingness and Ability to work.

If the applicant enters yet additional information into INVEST, including more evidence of their soft skills, references, a personal statement, and more, their credential will be expanded to an “improved” or “extended” credential.

### Employer Process

The employer process is considerably more streamlined and conventional than that of the applicant.

The employer comes to INVEST with a job opening, which comprises a job description, job qualifications, compensation description, etc. This will generally be entered via web input, although eventually this would be best to have as an automatic entry directly from the employer's internal database.

The employer would be able to scan through applicant résumés stored in INVEST (for all of WILLING, ABLE applicants). The employer is expected to contact, assess, vet, and interview the applicants. INVEST assists in this process by:

Assessing—Providing the hard skills assessment on which the applicant has, in many cases, been training. The résumé gives unvalidated assessment scores, but it is up to the company to assess whether the applicant is actually at the standard. This relieves from INVEST the almost impossible task of validating the hard skills scores. In addition, INVEST shows the effort and progress of the applicant as they move through the hard and soft skills training.

Vetting—Many of the applicants self reports will be checked via automated email verification. The results of this email verification will be available to the employer.

Interviewing—The interview is carried out by the employer, but the INVEST résumé includes a lot of information that is generally unavailable to the interviewer. The résumé highlights areas where validation of self-reported skills or experience is weak and bears discussion. “Ice-breakers” are suggested to get the discussion started, even where there could be large cultural differences. Strengths of the applicants are highlighted, as well as areas of concern.

When the employer has successfully found an applicant to fill the job, they indicate this to INVEST, and the employer is then billed.

### Career Tracking

Tracking Over a Career

The success of INVEST is ultimately determined by whether the applicants that are suggested to companies “work out”. Thus, it is incumbent on INVEST to maintain contact with the applicant after they begin work at a company, so as to handle, at least to some small extent, issues that arise over time as a person is at work.

This aspect of INVEST can comprise:

1) Giving applicants permanent access to the Work Center modules.

2) Providing help for more concrete problems. That is, the Work Center is intended as a general overview of work situations and issues. However, there are more concrete issues of how to deal with specific issues of problems with supervisors, work discrimination, poor reviews, etc.

3) Opportunities to discuss specific and general work issues with other people through Internet forums or other groups.

It should also be remembered that maintaining a presence with applicants after they get a job means that as people move on and up in their career, they may be in need of more services from INVEST. Having a long-term “relationship” with the system makes this a natural step, and the more people that use and depend on INVEST, the better it serves the business community as well.

Algorithm Development

Part of what INVEST offers to the business community is the notion that applicants who are Ready, Willing and Able will have improved chances for workplace success relative to others that have not given this certification. This will almost certainly be true.

However, it would also be valuable to employers if an indication of relative readiness among either those that have reached the certification, or those that have not, could be provided to them. Even though all applicants will be encouraged to obtain a Ready/Willing/Able certification, not all will. Some of the time this will be because applicants are not willing to put in the work, but it can also be because some applicants may have developmental or other disabilities that prevent them from obtaining the required hard skills. Also, some applicants may start the process with so few hard or other skills, that it will take weeks or months of work to obtain the certification, while INVEST will have them in the system for employers to view and possibly hire. Furthermore, there will be other applicants that have met the certification, but for one reason or another have aspects of their career that would indicate that they have relatively low chances for workplace success.

In the best of all possible worlds, INVEST would obtain from employers feedback as to which employees succeeded, and which did not, in order for the system to learn (through statistical algorithms) the mixes of applicant characteristics and job/employer characteristics that are successful or not. There are both legal and practical issues that would frustrate this scheme, and this is unlikely to work for the bulk of INVEST applicants or company clients.

Instead, it is suggested that a preferable approach would be to provide long-term career assistance for applicants. That is, if INVEST maintains contact with applicants over a period of time, by providing long-term career assistance, the applicants will provide the input data required for algorithm development. Thus, as an applicant loses a job, they would come back to INVEST to find another job, or to get advice on what they did wrong. If an applicant remains in a job, but requires advice, INVEST would determine that the applicant was still with their job, and would in fact learn specific things regarding those aspects of the job that the applicant found challenging. This information could serve an additional purpose in providing potential direction for the development of new INVEST training modules.

Thus, the career-tracking aspects of INVEST are not simply another way of assisting applicants, but also of obtaining the data needed to determine the likelihood of success before the applicant obtains a job.

How is it that this information could be utilized?

Success Prediction

Clearly, one possible use for this information is to predict for companies the likelihood of applicant job success. This could operate either in terms of strict job readiness of the applicant for any job, determined solely on the basis of characteristics of the applicant, or alternatively, in terms of compatibility—using information about the job characteristics in addition to the applicant characteristics. In theory, given enough data, one could potentially say that the given applicant is less likely to succeed in job A and more likely to succeed in job B.

A concern with this prediction is that the prediction may become “too accurate”. Consider, for example, the case that the prediction algorithms were 100% accurate—that it could in fact accurately predict which of two candidates would be more likely to be successful at a particular job. While this has huge value for companies, it has both good and bad outcomes for the applicants. Good applicants, clearly, are benefited—not only because they get the job, but also because they get jobs in which they will succeed.

On the other hand, applicants who currently have less skills might not get jobs even if they have the intention of or are working hard at improving their skills, or would contribute to a workplace or society in a way that is not directly related to job success (e.g. they bring diversity to the company, their success will encourage the success of others from disadvantaged backgrounds). It should also be noted that accuracy is measured in terms of the relative probabilities of staying in a job, not the relative success within a job. Applicant A may have a higher chance of staying at a job, whereas Applicant B could have a lower chance of staying at the job, but a higher chance of bringing something to the job or their community if they should stay. The algorithm would not be able to make this call.

Given that:

1) anything INVEST's algorithms say about the chances of job success will likely be over-utilized by client companies,

2) the algorithms are likely going to have only weak accuracy, and

3) as described above, the algorithms are not going to incorporate the highest social good (i.e. the algorithms will tend to suggest candidates with scores in hard skills and other more easily measured qualities),

it seems that the extent to which the results of the predictive algorithms will be shared with companies should be carefully considered. One way of dealing with some of the issues is to have very coarse grained predictions generated by INVEST. That is, instead of a continuous scale from 1-1000, INVEST could use three different predictions—e.g. UNCERTAIN, AVERAGE and HIGH chances for success. Even these methods, however, leave some applicants harmed by the prediction system.

Success Mentoring

Prediction of success will be based on some combination of applicant characteristics (the applicant's skill level, connection to their community, the number of jobs they have had, age, and other factors) and job characteristics (the job pay, distance from the applicant's home, manual work, etc). Some of these characteristics are outside of the applicant's ability to affect (e.g. their age), whereas others are (e.g. the job's distance from work, the applicant's skill level). The algorithm prediction can identify those factors that are under the applicant's control that will have the largest effect in improving chances for success.

Such a use of the predictive information has none of the concerns related to that of sharing the information with companies. The applicants become more efficient at improving themselves in ways that benefit both themselves and the employers, the employers get applicants who are more likely to succeed, and INVEST has happier applicants and employers.

### INVEST Applicant Interface

### Module Architecture

The required characteristics govern the look-and-feel of the user interface. The process flow described above governs the functional modules that are required to support the INVEST process. In the following subsections, functional modules will be described at an architectural level, with required information and processes described, but no indication of the look-and-feel or other characteristics.

NOTE: For purposes of this discussion, a module is a collection of one or more web pages with a common purpose.

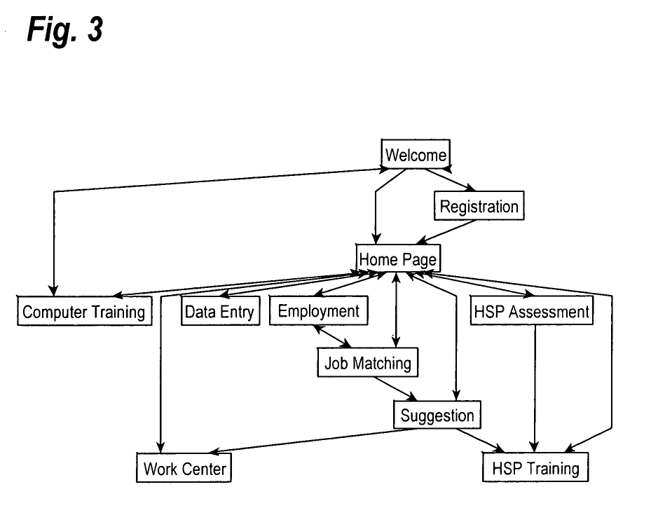

FIG. 3 is a schematic diagram of INVEST module architecture. It should be noted that the figure, as well as the descriptions that follow, gives a sense of a preferred system, and it is not necessary to implement ALL of the features to have a useful and operational system (or alternatively, all of the modules may be present, but some may be in a less complete form).

Welcome Module

This would comprise a single page that acts to draw applicants into the process. This page would establish the overall look-and-feel of the system, provide information as to the overall goal of the system, and would attempt to get new applicants to click over to a new registrants' page, and returning applicants to login.

The type of written information (supported by the look-and-feel) that might be offered directly in the welcome page, or indirectly through links in the page, includes:
1) Who is offering INVEST.
2) What can be obtained by using INVEST.
3) What are the obligations of INVEST.
4) Testimonials or INVEST statistics (i.e. INVEST works; other people like me use INVEST)

It should be noted that there can be an associated INVEST Education Module that can provide more in-depth descriptions of the operations and benefits of INVEST that could also be accessed from the Registration or Home Page modules (described below).

Registration Module

The registration module collects some part of the BIOGRAPHICAL ELEMENTS class, which could be as little as the CONTACT INFORMATION, or could additional include parts or all of the EMPLOYMENT HISTORY or the EDUCATIONAL HISTORY.

Computer Training Module

While not necessary, it would be good to be able to provide some free, basic computer use training as part of INVEST. This training would generally be available from the Welcome module, as well as the Home Page, and serves at least two purposes:

1) Users who are unfamiliar with computers can gain enough knowledge of computer use to use INVEST effectively (including to make use of any hard skills training or Work Center available in the system).

2) It serves as a marketing tool for INVEST—people with modest skills will come to the site in order to obtain training.

Optimally, this training would take no more than 4-6 hours for a well motivated person to use, could be taken at any web-based computer, would require only a trained computer user to get the applicant onto the Computer Training module web page, and would thereafter be entirely self-administered.

INVEST Education

This provides a more in-depth view of INVEST from the standpoint of an applicant. This will generally be more in-depth, and for use either by more sophisticated users of the system, or by mentoring organizations that are helping applicants. The current embodiment can include, but is not limited to the following list of module types.

Home Page Module

Home Page is where an applicant goes after logging into INVEST. This page has a summary of where in the data collection process the applicant is, shows the amount of training available that the applicant has taken, shows any progress steps with respect to applications with specific companies, shows products (résumés and other outputs) that are available to the applicant, and gives the applicant a list of actions that can be taken (enter more information, get more training, make an output, make an application, etc.). To the extent that community services (e.g. a social network) are built into INVEST, the Home Page also serves as a gateway into that network.

Because of the amount of information and activities that are built into the Home Page, the Home Page could potentially be comprised of multiple pages, or alternatively, the page can be reformatted with the press of a button to have a different look-and-feel and/or information presented depending on what is being done or by user choice. An alternative would be to have a set of tabs at the top of a single page, which would reformat the page according to which tab is pushed.

Data Entry Module

There are many INVEST elements, each with a rich “appetite” for information. Streamlining the process and making it enjoyable are key aspects of INVEST' success. Because of the amount of data, there are some characteristics of the data entry:

1) The applicant should be prompted for specific information. For example, most applicants will not understand the notion of WORKPLACE UNDERSTANDING, and will need to be asked for the specific supporting information needed to establish this element.

2) The system should be dynamic and non-linear. Instead of asking for each piece of information at each level, only introductory questions are first asked. For example, instead of asking for all information about TEAMWORK (where, with whom, dates, how it was done), INVEST can first ask general questions about TEAMWORK, and then follow-up on initial threads of information. This dynamic questioning favors an “interview” style of asking questions one or a few at a time, following up whenever a response is given.

3) Information about employment history, educational history, and participation in groups should be asked for first, so that this information can be used later in establishing referenceable information. For example, when TEAMWORK is discussed, all of the possible group situations can be presented to the applicant, who would then simply pick one or more of the already-entered groups or employers from a set of checkboxes.

4) To the extent possible, applicants should be provided with information as to why specific pieces of information are given. This serves three purposes:
a. The applicants have incentive to provide the information, and don't see it as an endless intrusion on their time and privacy.
b. The information serves partially as training for the way that business works, and as business will perceive them.
c. By explaining the concept behind asking for the piece of information, the applicant can be reminded of additional information that they could provide.

HSP Assessment

While most of the applicant data entry can be carried out in interview fashion, the HARD SKILL PROFICIENCIES assessment needs to be given as a formal assessment. In many cases, the applicant will want to take the assessment multiple times: (1) once as an early step in the INVEST process to determine whether the applicant meets the hard skills requirements, (2) after some training, to establish that they do in fact have the skills required, and (3) multiple times before interviews at employers, since the HSP assessment is a high-stakes test, and the applicant will want to make sure that they are as comfortable as possible before taking an assessment at an employer.

HSP Training

While not required for INVEST, it would be very helpful to have free HSP training, so that applicants that failed to meet the threshold could train themselves to pass the threshold, and which would additionally provide support of INITIATIVE and WORK ETHIC in the work that they put into the training.

Work Center

The Work Center corresponds roughly to training in Soft Skill Proficiencies (SSPs), and comprises both a large set of material, including videos, written and hypertext instruction, testimonials, forums for job seekers to communicate with one another, blogs, and other information to instruct and motivate.

Job Matching Module

Job matching will require its own module, and will include (not shown in the diagram) its own data input pages (e.g. for Career Interests) for that data that is not part of the elements, as well as the matching information that comes from the matching algorithm. In addition, there will likely be a jobs database with an interface that allows applicants to obtain useful information about specific jobs that are suggested by the system or which the applicant simply browses (indoor/outdoor, career/advancement potential, salary ranges, required skills, etc).

Suggestion Module

The value of the system is not simply to get applicants jobs, but to engage them to better their skills so that they can obtain better jobs. A suggestion module steps out of the data rich environment in which it may be hard for relatively unsophisticated applicants to make decisions, and to lay out for applicants what their choices are: apply for these given jobs, or get training in the following skills in order to prepare yourself for better jobs.

Employment Module

It should not be suggested or implied that INVEST will necessarily result in employment, and one of the lessons of INVEST should be that getting a job requires the applicant to do things and show initiative. An employment module would be directed specifically at the applicant, giving interfaces to:
the Job Matching Module,
outside resources for finding jobs (e.g. job boards of INVEST affiliates, locations of local Workforce Development Centers),
viewing, editing (e.g. selecting templates) and printing résumés generated by INVEST,
tutorials on interviewing techniques.

### INVEST Output

### Output Modes

In this section, various modes of presenting information to both employers and applicants are enumerated. As mentioned in the discussion of business models; each mode would correspond to an output module that could be selected by an employer or an applicant, and the modules for applicants and employers can be overlapping. Also, by letting the applicant see the output that would be seen by the employer, certain applicants can be able to gain insight into the process from the standpoint of the employer. The current embodiment can include, but is not limited to the following types of modes.

XML Output

XML output is a data transfer format that is widely readable by computers. In this mode, INVEST would simply transfer to the employer all data related to an applicant to the employer. Such an output could be read by any computer system, and is particularly well-suited for automated screening procedures by the employers. In addition, if desired, employers could create interfaces that present the information in a custom format, either on paper or by computer (e.g. browser output).

Conventional Résumé Format

This output recreates a conventionally formatted résumé. Indeed, a number of standard templates (education first, employment first, etc.) can be provided from which the employer or applicant could choose. The information in such a résumé is approximately:
Contact Information
a Work Experience—jobs listed with dates, title, rough job responsibilities, and accomplishments.
Education—school, concentration (if appropriate), degree/credential.
Skills—brief descriptions of work skills.
Personal/Other Activities—brief descriptions of non-work related activities.

Expanded Conventional Résumé

In an expanded conventional résumé, a conventional résumé is supplemented with information from the elements of Section 3. This would primarily expand on the Skills and Personal/Other Activities of a conventional résumé, and could be hierarchically organized roughly on the classes of the INVEST ontology (Biographical Element Class, Hard Skill Proficiency (HSP) Class, Soft Skill Proficiencies (SSP) Class, Attitude Class, and Asset Class).

Each piece of information can be optionally tagged with the evidence behind the information (e.g. “demonstrated”, “self-reported”, or “referenced”), which might highlight in consistent fashion the estimated strength of the evidence (either from the type of reference, the amount of reference verification, and the number of references).

This expanded résumé might also include other information, such as:
Links to uploaded information (e.g. from creative output)
Suggestions of information to verify from an interview, which might include unverified self-reports or information with conflicting support.
Suggestions of information to start a conversation with the applicant during an interview.

Graphical Summaries

Graphical elements could be added to résumés to provide easily comprehended summaries. As an example, graphical elements might include a bar chart of elements (grouped by class) with the height of the bar indicative of the rough level of advancement in that element. This would require a method of converting a set of quantitative plus qualitative data about an element (demonstrable, self-reportable and referenceable), and converting that to a uni-dimensional number. This would likely work well for some of the HARD SKILL PROFICIENCIES, but would be more challenging (though not impossible) for SOFT SKILL PROFICIENCIES, ATTITUDES, and ASSETS. This bar chart could be supplemented with a line representing either, but not limited to (1) a criterion-referenced threshold for high or adequate performance in each proficiency, or (2) a norm-referenced measure, such as 25-50-75-90th percentiles in each proficiency for some reasonable reference population.

Chronological Summary

For each element of information, INVEST will collect rough dates (of jobs, activities, education). In a chronological summary, this information would be arranged in chronological order, which can be
bars along a vertical or horizontal timescale, the bars indicating the duration of the job, activity, or education;
grouped by time period, with all of the activities active within a particular period of time (e.g. 3, 6, 12 or 24 months) being listed (and allowing some longer duration activities to be repeated in many different periods);
sequentially listed by start dates.

Exception Summary

The amount of information collected by this system will be vast compared to conventional résumés, and interpreting this information will be hard (and especially so, in the early stages of adoption). It should be of use for the system to detect “exceptions”, wherein an applicant is “unbalanced”, with very disparate strengths and weaknesses among elements. This exception summary highlights two possible situations of interest:

1) Related elements that show different patterns of strength and weakness could indicate either incorrect information, mistakes in data input, or fraud.

2) Large weaknesses or strengths relative to other elements that could be pointed out as either (a) hidden strengths that could be of interest to employers or serve as a foundation on which to build additional strengths for the applicant, or (b) particular problem areas for an applicant.

### Narrative Versus Static Chronologies

Standard résumé output has a static aspect—education and employment are laid out in chronological order, but without “connecting pieces”. That is, why did someone leave their job, what happened during those periods during which one was not employed or being trained? What was random accident and what was intentional? For purposes of discussion, the former type of résumé will be called a “static résumé” and a résumé that included information providing at least partial answers to those questions will be called a “narrative résumé”.

A narrative résumé has value for both the applicant and the employer. For the applicant, a narrative gives a sense of movement and potential. A static résumé does not strongly distinguish past and the present, and given that the majority of the information on the résumé might be “negative”, this doesn't give the applicant a sense of forward motion and potential.

For the employer, periods during which the applicant has not been positively engaged can be unreasonably emphasized in the selection process, and gaps in the chronology are strong “red flags” that could sideline a good candidate without some explanation. A clear view of the full trajectory of a candidate is important, and in particular for an applicant who has a more mixed past.

It is also true that some of the more modest accomplishments of some applicants will be better emphasized if the hurdles that the applicant had to overcome—either intrinsic hurdles such as bad choices or disabilities/illness, or extrinsic hurdles such as an adverse home or school or neighborhood environment—are indicated. For example, modest educational achievement could be considered a strength in the context of large adverse factors (teenage pregnancy, bad schools, etc.).

The value of a narrative résumé should also be weighed against the potential that the narrative might be filled with excuses and actually accent past mistakes. Part of what an employer is looking for is an applicant taking responsibility for their situation, not providing a litany of reasons why it “wasn't their fault”. Furthermore, recounting in larger detail past mistakes could magnify those mistakes, rather than simply place them in context.

One way of balancing the value of explanations with the detriments of over-emphasis is to both counsel the applicants as to how to present the information, as well as to limit in space or words and explanations (forcing the applicants to focus on the important aspects of the explanations).

### Summary of Terms

This Summary of Terms provides a convenient condensation of terminology used in this specification, which should not be limiting and should be considered in combination with further explication elsewhere in this specification, or as used or understood by those skilled in the art.

Employment-related information comprises biographical information, job history, evidence of personality or skills abilities, criminal records, credit scores, recommendations, or any other information that may be of interest or use to a prospective employer in evaluating the job fitness of a job seeker.

Validation of the employment-related information comprises two aspects. One aspect is the actual supplemental information indicating that the quality or nature or specifics of the employment-related information. A second aspect is confirmation of the provenance of the information, which often indicates the truth or value of the validating information. For instance, a recommendation is validating information. What is in the recommendation is the first aspect of validation, and then confirming that the purported author of the recommendation actually wrote the recommendation is the second aspect—the confirmation of the provenance.

In some cases, the validating information and evidence of the provenance can occur at the same time. An example of this would be a recommendation received from the email address of the purported author, or alternatively, an email can be sent to the recommender with a questionnaire to be filled out by the recommender. In many cases, however, the two aspects will be separated in time, such as the case of a recommendation received from a recommender, and then an email will be sent to the recommender, containing the recommendation, so that the recommender can confirm that they were the author of the recommendation.

Some examples of validation may clarify the intended meaning. For instance, the jobseeker may say that they play an instrument. The validation could comprise program notes from a recital, a recording of the seeker playing a piece of music, a recommendation from a music teacher, a review from a newspaper, a note from an organization sponsoring a concert, a letter from an accompianist, or other such support. The validation comprises both the information provided (e.g. the program notes, the recording, etc.), as well as confirmation that the source of the information is correct, legitimate, from the claimed source, etc.

A data store is a database of employment-related information and validation, which is in general searchable for such information, and from which the information can be retrieved.

Wide area networks comprise the internet and the telephone system (whether conventional landline, cellular, and/or voice-over-IP).

The types of validation information is extensive, and generally is evidence of the job seeker's abilities, qualities, or accomplishments that gives depth, understanding, explication, and confirmation to the employment-related information, and is of benefit to the prospective employer in evaluating the job seeker. It can comprise audio information, which can be a choral concert, an instrument or voice recital or demonstration, a personal statement by the job seeker or an audio recommendation, or other such audio record. It can comprise textual information, which can include a written personal statement, a third party recommendation, a short story, poem or other fictional work, a nonfiction work product or white paper, a playbill or program notes of a performance, a review of something done by the job seeker, or other such textual information related to the job seeker. It can comprise pictoral or video information, which can be photographs taken by the job seeker, taken of the job seeker, or taken of something done by or related to the job seeker, art work created by the job seeker, or other pictorial information related to the job seeker.

A third party is an individual or entity other than the prospective employer and the job seeker who or which has information related to the job seeker of potential interest to the prospective employer. Examples of a third party comprise job seeker teachers, mentors, employers, collaborators, preachers, rabbis, imams, supervisors, subordinates, family members, friends, and other people who may have knowledge of the job seeker of relevance to the employment process.

Confirmation of the validation can be made through a variety of means. As mentioned above, an email can be sent to an address for a person's verified response. For example, sending an email to roger.collins@rogerscorp.com that is then responded to with either information about the job seeker or with confirmation that another submission of validation information was from the claimed person. It can also comprise a telephone confirmation, which could include an automated telephone call, where the person at the end of the line either presses keypad keys in order to indicate responses, or where the person is prompted for information, which is then stored as an audio file and/or converted by speech-to-text software into text.

A skills test is broadly construed, and can comprise tests that assess hard and/or soft skills. The tests can be either online tests, or can be tests which are given in hard copy form (e.g. where PDFs are provided online for job seekers to take and score at a place other than a place of employment). Importantly, it is preferable for tests to be taken twice—once, where the job seeker takes the test in a private or non-employment setting (e.g. at home, or at a library or a job development center) and reports on the result, and once where the job seeker takes the test at a place of prospective employment. In this way, the prospective employer can unambiguously certify that the job seeker has the rough level of skills that are claimed, and but can make the decision whether to bring the job seeker in for an interview and testing on the basis of self-reported skills.

The strength of validation means the degree of certitude of the system either that the provenance of information is correct, or that the certification itself is of value. For example, it could be that a certificate was indeed issued by the organization that is claimed to have issued the certificate, but it could be that the certificate is of limited importance or value. The strength of the validation can be related either to the certitude of provenance, or the value, or both. In the preferred situation, the value or meaning of a piece of validation will be indicated by the source of the information, in which case the value of the validation can be roughly estimated by the certitude and reputation of the source.

A résumé means a collection of employment-related information within a relatively consistent or organized fashion. The format can comprise a conventional text résumé, an electronic résumé, a résumé with attached supplementary information, a set of forms, a video résumé, or whatever format is used to convey information about the job seeker to a prospective employer.

For a format to link two pieces of information, for example employment-related information and validation information, the relationship between the two pieces of information must be clearly related either through positioning (e.g. together on a line), content (e.g. words that indicate that the validation is related to the employment-related information), visual clues (e.g. they share the same colors, or colors for employment-related information are one color and for validation in another), meta-tags (e.g. if the résumé is in electronic form, the association of tags for each field indicating the purpose or content of the field), or through other means that are interpretable to the prospective employer.

### Many Embodiments within the Spirit of the Present Invention

It should be apparent to one skilled in the art that the above-mentioned embodiments are merely illustrations of a few of the many possible specific embodiments of the present invention. It should also be appreciated that the methods of the present invention provide a nearly uncountable number of arrangements.

Numerous and varied other arrangements can be readily devised by those skilled in the art without departing from the spirit and scope of the invention. Moreover, all statements herein reciting principles, aspects and embodiments of the present invention, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

In the specification hereof any element expressed as a means for performing a specified function is intended to encompass any way of performing that function. The invention as defined by such specification resides in the fact that the functionalities provided by the various recited means are combined and brought together in the manner which the specification calls for. Applicant thus regards any means which can provide those functionalities as equivalent as those shown herein.

What is claimed is:

1. A method for validating employment-related information regarding a job seeker for use by a prospective employer in a hiring decision, comprising:
entering the employment-related information into a data store connected to a wide-area network by the job seeker;
providing validation into the data store in conjunction with the employment-related information over the wide area network; and
transferring to the prospective employer from the data store over the wide-area network the validation in conjunction with the employment-related information.

2. The method of claim 1, wherein the validation is provided by the job seeker, and comprises supplemental information selected from the group consisting of audio information, textual information, pictoral information, or video information.

3. The method of claim 1, wherein the validation is provided by a third party, wherein the validation comprises supplemental information selected from the group consisting of audio information, textual information, pictoral information, or video information.

4. The method of claim 3, wherein the third party is contacted to confirm the validation, and the contact is made via an automated system through a means selected from the group consisting of email and telephone.

5. The method of claim 1, additionally comprising testing the jobs seeker's skills with a skills test, the results of which are stored in the data store and transferred to the prospective employer.

6. The method of claim 5, wherein the job seeker completes the skills test a second time under the supervision of the prospective employer.

7. The method of claim 1, wherein the prospective employer is additionally transferred information about the strength of a validation.

8. A system for validating employment-related information regarding a job seeker for use by a prospective employer in a hiring decision, comprising:
a data store for storing the employment-related information, wherein the data store is connected to a wide area network;
validation data associated with the employment-related information, wherein the validation data is stored with the associated employment-related information in the data store; and
a transfer interface that retrieves employment-related information and its associated validation information from the data store for transfer to the prospective employer over the wide-area network.

9. The system of claim 8, wherein the validation is provided by the job seeker, and comprises supplemental information selected from the group consisting of audio information, textual information, pictoral information, or video information.

10. The system of claim 8, wherein the validation is provided by a third party, wherein the validation comprises supplemental information selected from the group consisting of audio information, textual information, pictoral information, or video information.

11. The system of claim 10, wherein the third party is contacted via an automated system through a means selected from the group consisting of email and telephone.

12. The system of claim 8, additionally comprising testing the jobs seeker's skills with a skills test, the results of which are stored in the data store and transferred to the prospective employer.

13. An electronic résumé regarding a job seeker for use by a prospective employer in a hiring decision, comprising:
employment-related information onto a data store over a wide-area network;
validation information for the employment-related information; and
a format that links the employment related information to its associated validation information into the electronic résumé.

14. The résumé of claim 13, wherein the validation information comprises supplemental information selected from the group consisting of audio information, textual information, pictoral information, or video information.

15. The résumé of claim 14, wherein the validation information comprises third party source information, and wherein the résumé additionally comprises confirmation of the provenance of the information.

16. The résumé of claim 15, wherein the confirmation comprises contact of the third party via an automated system through a means selected from the group consisting of email and telephone.

17. The résumé of claim 13, additionally comprising a score from a skills test, wherein the test is available for use by the prospective employer for confirmation of the job seeker's ability as evidenced by the score.
